(19) United States
(12) Patent Application Publication
(10) Pub. No.: US 2004/0199593 A1
(43) Pub. Date: Oct. 7, 2004

(54) Means of electronic communication

(76) Inventor: Todd Simpson, Calgary (CA)

Correspondence Address: TODD SIMPSON, 11 EDENSTONE VIEW N.W., CALGARY, AB, T3A3Z2, CA

(21) Appl. No.: 10/774,877

(22) Filed: Feb. 10, 2004

Related U.S. Application Data
(60) Provisional application No. 60/319,951, filed on Feb. 17, 2003.

(51) Int. Cl. G06F 15/16

(52) U.S. Cl. 709/206; 709/203

(57) ABSTRACT

This invention presents a novel way in which electronic communication can be carried out, wherein the context of the communication is established by negotiation between the sender and receiver, whereby the communication can be properly categorized and filed.

### CROSS-REFERENCE TO RELATED APPLICATIONS

This application is a non-provisional version of U.S. provisional application No. 60/319,951 filed Feb. 17, 2003.

### BACKGROUND OF INVENTION

This invention pertains to the exchange of electronic information, and more specifically to an email-like exchange wherein the categorization of information being exchanged is more easily controlled and exposed. This invention pushes the responsibility for message management to the sender of the message, as opposed to the recipient, but under rules imposed by the recipient.

### SUMMARY OF INVENTION

The growth of the Internet has lead to an ever-increasing amount of unstructured communication. This communication is largely accomplished via email and instant messaging systems, as well as, to a smaller extent, ftp or similar means. The increase in information has lead to an increase in the amount of time a user spends sorting and organizing their communication information.

Existing email systems can be characterized as being a one-way broadcast of information having both a sender and a receiver. The sender composes the message and provides some indication as to the nature of the message in the header line. The receiver categorizes email he receives based upon the senders name, keywords in the header line or message, or more sophisticated tools for identifying spurious email. Email is non-real time and asynchronous (from the viewpoint of a human); the receiver does not have to read the email immediately, nor do they need to respond.

Instant messaging is real-time and synchronous. Here there is a dialog (back and forth) requiring a timely response. Instant messaging, like human dialog, tends to first establish the context of the interaction (what the conversation is about), and then proceed to a more meaningful exchange of information. This should be contrasted with an email broadcast where the context (categorization) is largely established on the receiving end.

There exists a need, therefore, for a non-real time, asynchronous communications system with the advantages of negotiating a context. Because of the asynchronous nature of the system, the context setting must be done by something other than dialog (the receiver may not be available). Either the context is transmitted in a more structured form (perhaps relying on a-priori information about the receiver), or the context is negotiated between an agent for the sender and an agent for the receiver, or a third party can negotiate the context between an agent for the sender and an agent for the receiver.

### BRIEF DESCRIPTION OF DRAWINGS

FIG. 1 shows a general electronic mail system, at the levels of user actions and agent actions.

FIG. 2 shows an electronic mail system with the addition of negotiation for the context of the message.

FIG. 3 abstract FIG. 2 into major components.

FIG. 4 shows the present invention with an intermediary helping to negotiate the context for the message.

FIG. 5 shows the system with messaging gateways.

FIG. 6 shows the system with multiple recipients of a message.

FIG. 7 shows the combination of multiple recipients and an intermediary.

FIG. 8 shows the use of multiple intermediaries.

FIG. 9 shows a users view of the context setting system.

FIG. 10 shows a users view of the context setting system when multiple recipients are involved, and all recipients have the same context.

FIG. 11 shows a users view of the context setting system when multiple recipients are involved and each recipient has a different context.

### DETAILED DESCRIPTION

An agent is an automated system that, once configured by a user, has some independence of action. An intelligent agent may change its behavior over time based upon its interactions with other users and/or other agents. An agent may be distributed or local, autonomous or controlled. Thus, for our purposes, an agent is any software system.

At the core of this invention is the increased responsibility of the sender of a message to categorize information being sent out. At the time that communication is initiated, the sender has more information about the context that the receiver. This information is valuable, and should be used to help the receiver categorize the communication in more than an ad-hoc, post receipt, manner (such as reading the subject line, or scanning for keywords). Instead, both the sender and receivers preferences for categorization should be unified as the message is composed and sent, so that it is properly indexed for all users.

The knowledge representation of context or categories will not impact the current invention, as long as that representation has a means for unifying two of more categories. For example, in a generic knowledge representation framework, unification may consist of finding the smallest subset that contains all categories. In a neural network, unification may consist of inserting all categories as the inputs to the neural network and then recording the output value. The knowledge representation structure may be distributed or local or both. The current invention is independent of this representation. It does, however, assume the existence of a categorization structure.

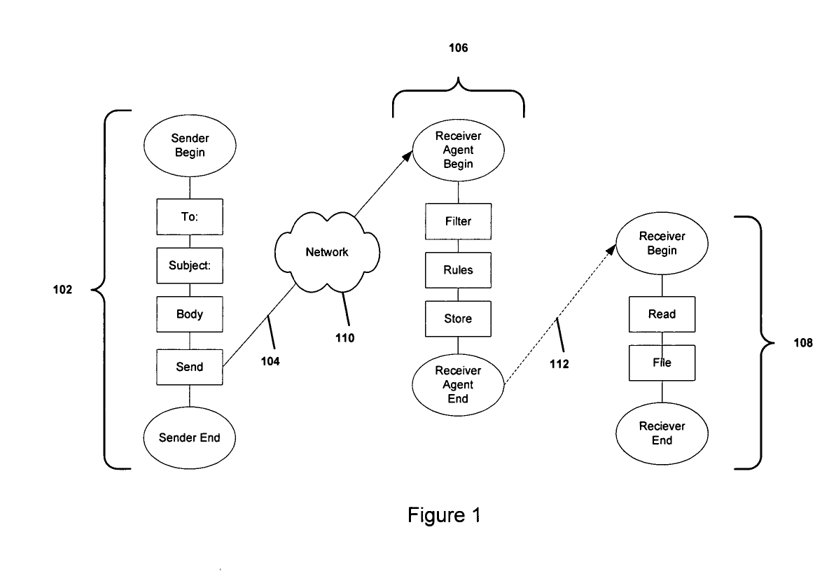

FIG. 1 shows a generic email application. Component 102, which we call the Sender, comprises of the user actions of deciding who the message will be sent to, the subject of the message, the body, and the send command. The send command results in the transfer of the message, 104, through the network, 110. 104 is intended to capture the standard Internet protocol for addressing and delivering a message, or any other means of finding the receiver and delivering a message. The Receiver Agent, 106, typically filters unwanted email, runs email rules to file messages, and then stores the message. The human Receiver, 108, then reads and potentially files the message. Here we see the difference between an Agent, which runs independently and asynchronously, from the Receiver, which is user controlled.

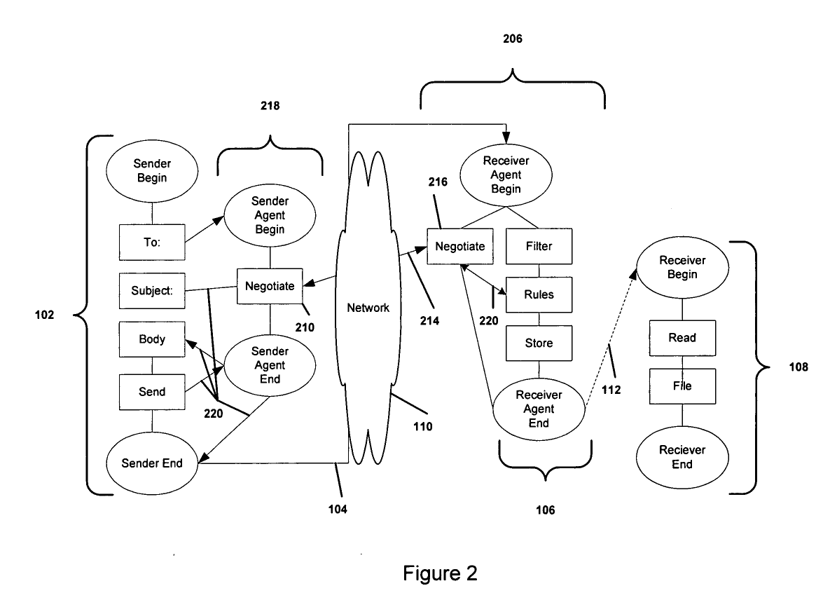

FIG. 2 shows the fundamental innovation of this invention; it shows the change required for the Sender to categorize a message. There is either a simple or complex interaction between the Sender and a Sender Agent. During or after a message composition, the Sender Agent must negotiate, 210, the categorization of the message with the Receiver Agent, 206, which has been modified with the ability to negotiate, 216. This negotiation occurs over the network, 110, using any type of communication scheme, 214. The Receiver negotiation and categorization will be based upon some knowledge of the recipients desires and/or file structure and may be influenced by the filtering or rules, 220, that the receiver has in place. The categorization may be based upon any type of knowledge representation.

The senders categorization may be influenced not only by the receiver, but also by information in the body or subject, 220, as well as any type of knowledge representation of the senders preferences. Thus, FIG. 2 shows the new interplay in the composition of a message which puts some of the responsibility for categorization on the sender and the Sender Agent.

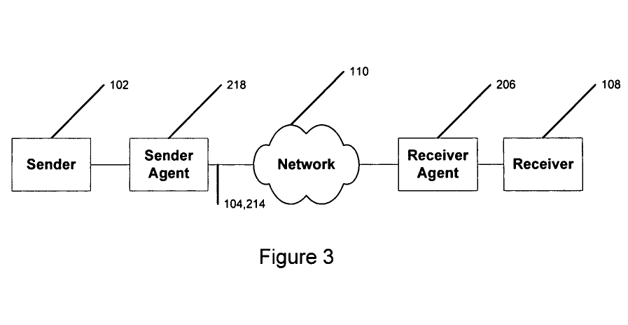

This new view of electronic dialog is shown in FIG. 3, where the Sender, 102, the Sender Agent, 218, the Network, 110, the Receiver Agent, 206, the Receiver, 108, and the methods of communication, 104 and 214, are all pictured. From hereon we will use 104 as a proxy for both 104 and 214 under the assumption that the same underlying protocol is used for both negotiation and delivery. This should not in any way restrict the current invention from cases where the two methods differ.

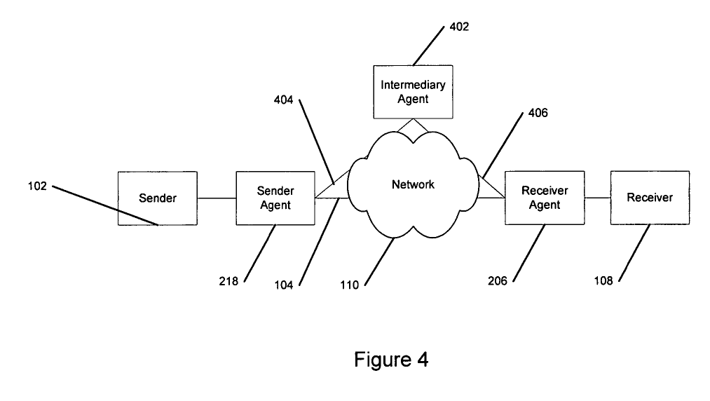

Implicit on both the sender and receiver sides is a representation of applicable categories, as well as, potentially, the ability for learning of categorization, or even the ability for the sender to update the receivers categorization and/or knowledge representation. In FIG. 4 we generalize this idea to include an intermediary Agent, 402. This agent may have knowledge of general categorizations with a world view, or an enterprise view, for example. The Sender Agent, and therefore the sender, can interact with the Intermediate Agent over link 404, and the Receiver Agent, and therefore the Receiver, can interact over link 406. These communications are in addition to, not to the exclusion of, link 104. In this case the negotiation for a proper categorization is three way. The Intermediary may use a standardized set of categories, or reflect an industry viewpoint. Either the Sender or Receiver can nominate an intermediary.

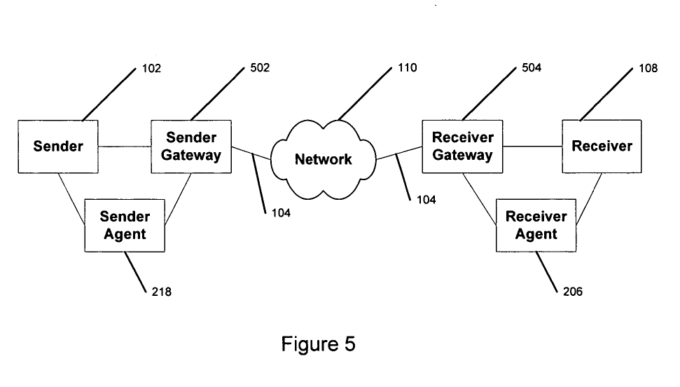

In FIG. 5 we show that gateways can be either transparent to, or participants in, a categorization. The Sender Gateway, 502, and the Receiver Gateway, 504, may be categorization agents in their own right or they may simply pass information. An example of participation would be enterprise based filtering of some content types (humor, pornographic material).

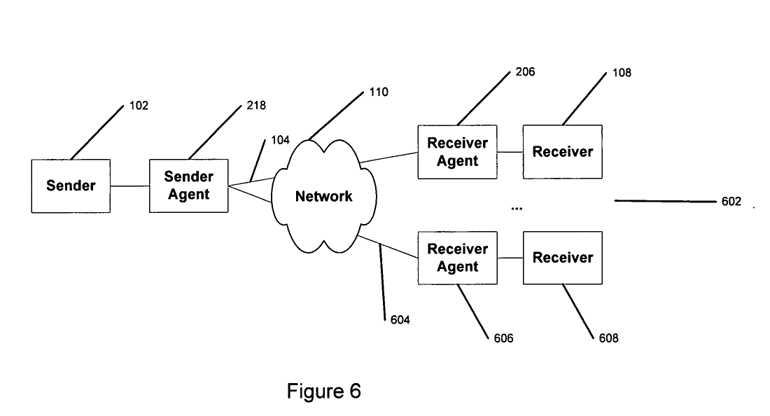

FIG. 6 shows the system with multiple receivers, 108 and 608, as well as receiver agents, 206, 606. Two receivers have been shown, although in general any number can be addressed, shown by “. . .” 602. The categorization procedure in this case can occur between the Sender Agent directly with each recipient, 104 and 604, resulting in potentially different categories for each user, or the Sender Agent may unify the category for both recipients based on negotiation with both.

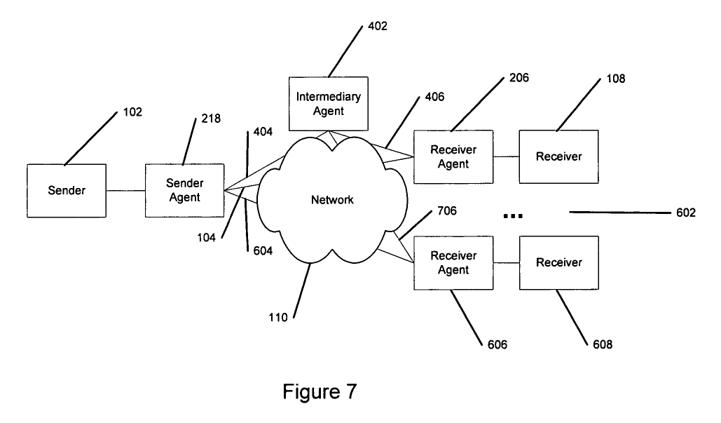

FIG. 7 generalizes FIG. 6 to the case where there is an intermediary agent. In this case communication is possible between all of the parties, adding links such as 706.

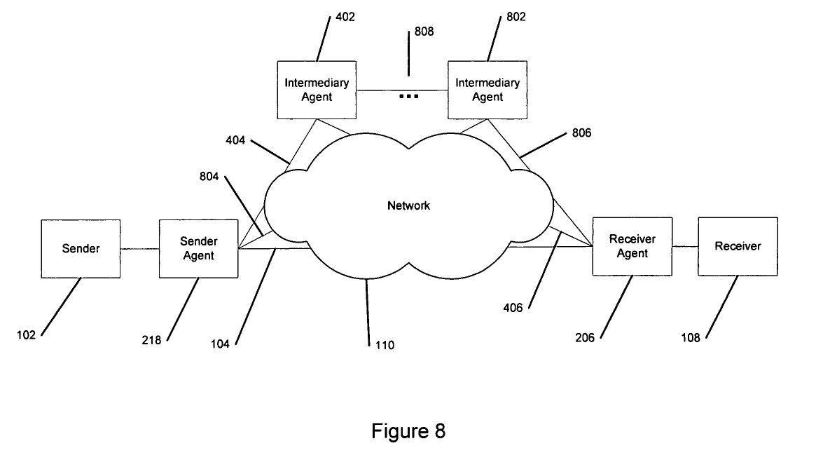

FIG. 8 generalizes once more to multiple intermediaries and the question of who controls the interaction becomes prevalent. Again, either a sender or receiver can nominate an intermediary, meaning that each receiver may nominate a different intermediary. As long as the intermediaries can all access one another, the unification of the categorization can proceed. As the Sender is the only endpoint with access to knowledge of all intermediaries (under the assumption that multiple recipients have no knowledge of each other for example in the case of blind carbon copies), the management role falls to the sender. If the sender nominates an intermediary, it can also pass on the address of other intermediaries, so the intermediaries can negotiate at one layer removed from the sender and receiver, for example agent 802 over line 808 and 806.

This reflects the preferred embodiment of category negotiation.

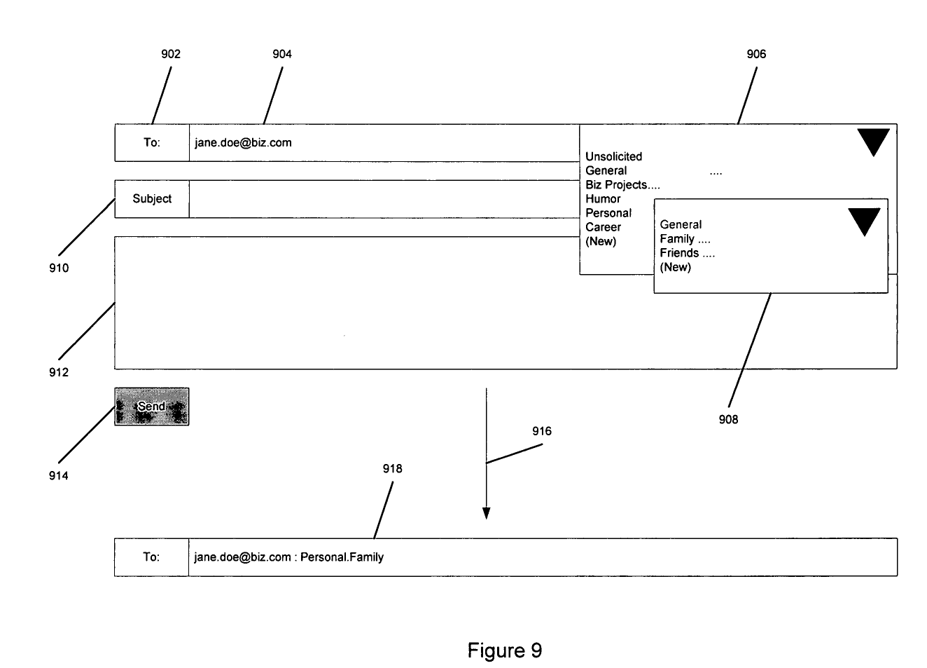

FIG. 9 reflects one possible user view of the interaction. Here a message is being sent to Jane Doe, 904, and categorization information has been presented for selection in drop down list 906 and sub menu 908. Behind the scenes the Sender Agent, given the information jane.doe@biz.com, 904, was able to negotiate these categories with the receiver agent for Jane Doe. The sender has traversed the categories to “personal” in 906, and retrieved the submenu 908. Within 908 there are three active subcategories, and one inactive one. The inactive category, “General”, indicates that Jane has a Personal. General category, but that it is not available to this sender. However, Jane also has a “(New)” category, meaning that she is willing to negotiate (herself or through her agent) a new category for this sender such a category may only be exposed to this sender, not others, or it may be made public and available for all. We also see in 906 a category for “Biz Projects which has company specific categories in it these categories may be driven by an enterprise intermediary, and can be consistent across all Biz employees. A selection of a category would result in a reflection of the selected data in the to field, 918.

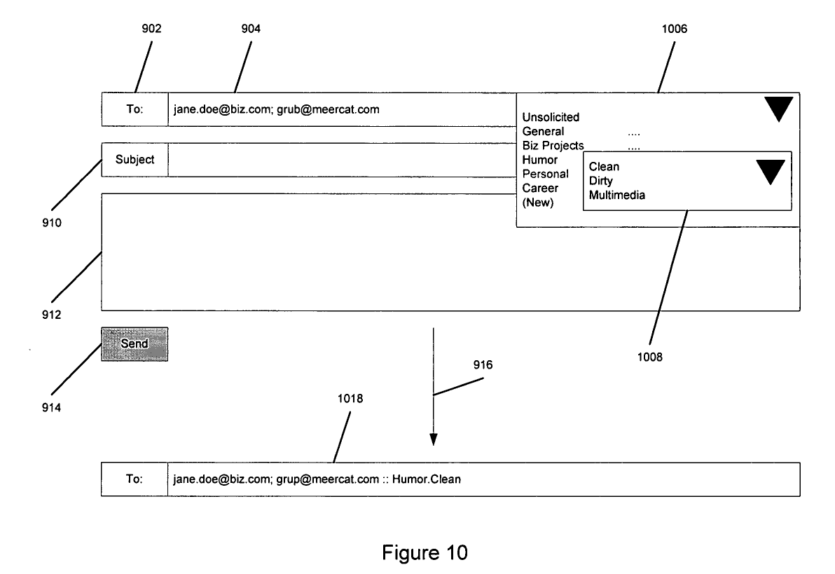

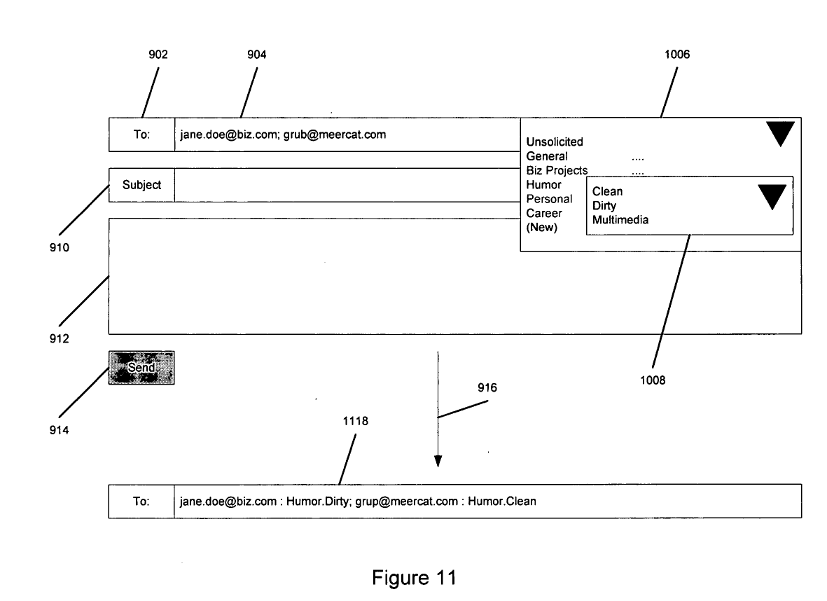

FIG. 10 shows the same view where multiple recipients are named. In this case a category, “Humor.Clean”, 1018, has been negotiated and applied to both users. FIG. 11 shows where different categories have been assigned to different recipients, 1118.

These interfaces are presented for description only and could be developed in many different ways. In particular, categorization may not occur until after the subject field is filled, 910, the body is filled, 912, or the send button pressed, 914. The first two of these may provide more information to the categorization process for example, keywords in the subject. Further, the view of the category may not be in the “to:” field, but may be in the subject field or the body, or even as an attachment, hidden or not.

Of course, the categorization allows for intelligent filling of sent messages, as well as received ones.

Presence information (such as whether a user is online, whether they are accepting messages, whether they want to be involved in categorization) can also be used to guide the system.

Therefore, this description is merely illustrative, and the present invention is defined solely by the claims that follow and their full range of equivalents.

I claim:

1. A system for effecting digital communications, said system comprising:
a sending subsystem comprising:
a message categorization means using information about the receiver in order to categorize the outgoing message
a presentation means of said categorization to the sender so that the message can be categorized
a receiving subsystem comprising:
a means of receiving a categorized message, and storing and indexing it according to said categorization.

2. The system in claim 1 where the categorization makes use of presence information.

3. The system in claim 1 where the presentation and selection of acceptable categories includes negotiation with an agent for the receiver.

4. The system of claim 1 where the presentation and selection of acceptable categories includes negotiation with an intermediary agent.

5. The system of claim 1 where the presentation and selection of acceptable categories includes negotiation with an agent for the receiver and an intermediary.

6. A system for effecting digital communication, said system comprising:
a negotiation subsystem comprising:
a means for the sender to configure a sending agent to negotiate a categorization, either automatically or with sender input
an agent for the receiver which negotiates with the agent for the sender in order to find a common ground between the senders expectation of categorization and the receivers current categorization
a sending subsystem comprising:
a presentation means for the sender in order to configure the sending agent and/or participate in the negotiation of categorization
a receiving subsystem comprising of:
a means of configuring the receiving agent so that it can negotiate categorization with the sending agent.

7. The system of claim 6 wherein the subsystems make use of presence information.

8. The system of claim 6 where there are multiple receivers and/or multiple agents for receivers.

9. The system of claim 6 where negotiation includes the use of one or more intermediaries.

10. A system of electronic communication comprising:
a negotiation subsystem comprising:
a means for the sender to configure a sending agent to negotiate a categorization, either automatically or with sender input
an intermediary agent which automatically mediates the categorization between the sender/sender agent and the receiver agent
an agent for the receiver which negotiates with the intermediary agent and/or the sender agent in order to find a common ground between the senders expectation of categorization and the receivers current categorization
a sending subsystem comprising of:
a presentation means for the sender in order to configure the sending agent and/or participate in the negotiation of categorization
a means for finding an intermediary agent
a receiving subsystem comprising of:
a means of configuring the receiving agent so that it can negotiate categorization with the sending agent.

11. The system of claim 10 where presence information is used to help with categorization.

12. The system of claim 10 where there are multiple receivers and/or multiple agents for receivers.

13. The system of claim 10 where categorization involves one or more intermediaries.
